(19) United States
(12) Patent Application Publication
(10) Pub. No.: US 2026/0296941 A1
(43) Pub. Date: Oct. 1, 2026

(54) OXYGEN OR HYDROGEN FUNCTIONAL WATER PRODUCTION DEVICE

(71) Applicant: Cosan Co., Ltd., Gwangju-si (KR)

(72) Inventors: Kil Ho Kim, Gwangju-si (KR); Hee Tae Kim, Gwangju-si (KR); Hee Won Shin, Gwangju-si (KR)

(73) Assignee: Cosan Co., Ltd., Gwangju-si (KR)

(21) Appl. No.: 19/251,324

(22) Filed: Jun. 26, 2025

(30) Foreign Application Priority Data
Mar. 27, 2025 (KR) 10-2025-0039415

(51) Int. Cl. C02F 9/00; B01F 23/232; B01F 25/433; B01F 101/00; C02F 1/28; C02F 1/461; C02F 101/10; C02F 103/02

(52) U.S. Cl. CPC C02F 9/00; B01F 23/2323; B01F 25/4331; B01F 2101/305; C02F 1/281; C02F 1/283; C02F 1/288; C02F 1/46109; C02F 2001/46142; C02F 2101/10; C02F 2103/026; C02F 2201/005; C02F 2201/46115; C02F 2201/46145; C02F 2201/46185; C02F 2209/40; C02F 2301/046

(57) ABSTRACT

Provided is an oxygen or hydrogen functional water production device, comprising: a water bottle containing water; a faucet to which the water bottle is fixed; a faucet nozzle inhaling the water contained in the water bottle and discharging water circulated inside the housing; a circulation pump pumping the water introduced through the faucet nozzle to circulate the water along the flow path; an electrolytic cell electrolyzing the water to generate oxygen and hydrogen gases, converting the water into functional water with a changed concentration of dissolved gases, and discharging the functional water; a filter assembly provided on the flow path through which water circulates, converting the water into alkaline water while removing ozone from the introduced water, and discharging the alkaline water; and a static mixer provided on the flow path through which the functional water circulates.

### CROSS REFERENCE TO RELATED APPLICATION

The present application claims the right of priority to and the benefits of Korean Application No. 10-2025-0039415 having a filing date of Mar. 27, 2025, the content of which is hereby incorporated by reference in its entirety.

### TECHNICAL FIELD

The present disclosure relates to an oxygen or hydrogen functional water production device, and more specifically, to an oxygen or hydrogen functional water production device that changes the concentration of dissolved gases (hydrogen or oxygen) in water circulating through the device using dissolved gases (hydrogen or oxygen) generated by the electrolysis of water, thereby providing oxygen water or hydrogen water to enhance solubility, permeability, and physiological effects.

### BACKGROUND

Water is an essential resource for the human body and plays a significant role in promoting health and supporting various daily activities. Technology that utilizes water as oxygen or hydrogen functional water by adjusting physical and chemical properties of water has become a major method for improving the quality of drinking water.

Oxygen or hydrogen functional water is utilized for health supplements and industrial applications by providing specific properties such as solubility, permeability, oxidation-reduction potential (ORP), and the concentration of dissolved gas (e.g., hydrogen or oxygen).

Oxygen or hydrogen functional water for drinking purposes mainly aims to enhance antioxidant effects and increase the concentration of dissolved hydrogen or dissolved oxygen to support oxygen supply in the body.

However, as time passes, the dissolved hydrogen and the dissolved oxygen tend to escape from the water, which may lead to quality deterioration during the storage and distribution of drinking water.

Meanwhile, minerals naturally dissolved in water can positively affect the solubility of the water and the retention rate of dissolved gases by influencing hydrogen bonding and the physical structure between water molecules. In particular, minerals such as calcium (Ca), magnesium (Mg), and potassium (K) contribute to improving the solubility and permeability of water, while maintaining the concentration and stability of dissolved hydrogen and oxygen.

Such characteristics are important factors for enhancing the storage stability of functional water and maximizing health benefits.

Conventional technologies for generating oxygen or hydrogen functional water have focused on increasing the concentration of dissolved hydrogen and oxygen, but have limitations in simultaneously improving the effective utilization of minerals and the long-term retention of dissolved gases.

Moreover, problems such as water spoilage and bacterial contamination due to air exposure may deteriorate the safety and reliability of drinking water.

Accordingly, a new technology that simultaneously increases the dissolution rate and the retention rate of dissolved hydrogen and oxygen by utilizing the effects of minerals dissolved in water and enhances the quality and stability of drinking water by overcoming the issues related to water spoilage and bacterial contamination is required.

Oxygen water and hydrogen water generating devices which are currently available on the market are configured as independent systems, requiring users to purchase separate devices or install additional equipment to utilize both functions, which reduces user convenience and causes inefficiency in terms of installation space and cost.

Furthermore, conventional devices are limited in effectively controlling the size of dissolved gases, which may result in poor swallowing comfort or slow absorption in the body. In particular, due to the lack of technology for reducing the cluster size of water molecules, it is difficult to maximize the bioavailability of dissolved oxygen or hydrogen.

As an example of the conventional art, Korean Patent Publication No. 10-2009-0113099 (Oct. 29, 2009) may be referred to.

### SUMMARY

It is an objective of the present disclosure to provide an oxygen or hydrogen functional water production device capable of selectively generating oxygen water and hydrogen water using a single apparatus and reducing the cluster size of water and dissolved gases (hydrogen or oxygen) through a static mixer provided in a flow path through which functional water circulates, thereby providing high-quality functional water with enhanced drinking comfort and improved absorption in the body.

Embodiments of the present disclosure provide an oxygen or hydrogen functional water production device, comprising: a water bottle containing water; a faucet located on a front side of a housing and configured to receive the water bottle; a faucet nozzle provided in the faucet and configured, when the water bottle is mounted to the faucet, to be positioned inside the water bottle, to draw the water contained in the water bottle, and to discharge water circulated through a flow path inside the housing; a circulation pump connected to the faucet nozzle via the flow path through which water circulates, and configured to pump the water drawn by the faucet nozzle so as to circulate the water through the flow path; an electrolytic cell provided on the flow path, configured to electrolyze water introduced therein to generate oxygen and hydrogen gases so as to convert the water into functional water with a changed concentration of dissolved gases, and configured to discharge the functional water; a filter assembly provided on the flow path, configured to convert the water introduced therein into alkaline water while removing ozone from the water introduced therein, and configured to discharge the alkaline water; and a static mixer provided on the flow path, and configured to mix the water and gas flowing through the flow path so as to generate microbubbles.

In an embodiment, the electrolytic cell may comprise: a lower member formed as a hexahedron with an open top surface and an internal space; an upper member coupled to an upper side of the lower member and formed as a hexahedron with an open bottom surface and an internal space; a proton exchange membrane arranged in a space between the lower member and the upper member, and allowing only hydrogen ions to pass through; and a pair of electrode plates respectively placed in surface contact with upper and lower sides of the proton exchange membrane to form electrodes.

In an embodiment, each of the pair of electrode plates may comprise: a plate-shaped titanium base; and a platinum coating formed on the surface of the titanium base.

In an embodiment, the electrolytic cell may be configured to generate reactive oxygen species (ROS) through water oxidation at a current density in the range of 500 to 833 A/m².

In an embodiment, the filter assembly may comprise: a first filter configured to remove ozone from the water discharged from the electrolytic cell; and a second filter configured to elute minerals into the water discharged from the first filter so as to convert the water into alkaline water.

In an embodiment, the first filter may comprise one of a compressed activated carbon block and an activated carbon fiber, and the second filter may comprise porous beads processed by impregnating activated carbon with potassium metabisulfite (KHSO₃).

In an embodiment, the static mixer may comprise a gas-liquid mixer having a coil shape. From the center of the coil toward a front end or a rear end, a diameter of the coil may increase and a spacing between adjacent turns of the coil may decrease.

In an embodiment, the oxygen or hydrogen functional water production device may further comprise: a flow sensor provided on a section of the flow path connecting the faucet nozzle and the circulation pump, and configured to detect water flowing from the faucet nozzle to the circulation pump and to control the operation of the circulation pump and the electrolytic cell.

In an embodiment, the oxygen or hydrogen functional water production may further comprise: a solenoid valve provided on a section of the flow path connecting the filter assembly and the faucet nozzle, and configured to close the section of the flow path after the operation of the circulation pump is terminated so as to prevent remaining water from dripping from the faucet nozzle due to residual pressure.

In an embodiment, the oxygen or hydrogen functional water production device may further comprise: a purification tank provided on the flow path, and configured to remove foreign substances from the water introduced therein and to discharge purified water; and a hot water tank provided on the flow path, and configured to heat the water introduced therein to a predetermined temperature and to discharge hot water.

In an embodiment, the oxygen or hydrogen functional water production device may further comprise: a light emitter disposed adjacent to the faucet, and configured to emit light of a selected color corresponding to the oxygen or hydrogen water discharged from the faucet nozzle.

In an embodiment, after the generation of oxygen functional water is completed, the electrolytic cell may be turned off and the circulation pump may remain turned on to perform idle circulation for one to two minutes, thereby circulating ozone, which is generated during the generation of oxygen in the electrolytic cell, to the filter assembly for removal.

### BRIEF DESCRIPTION OF THE DRAWINGS

FIG. 1 is a schematic diagram illustrating an oxygen or hydrogen functional water production device according to a first embodiment of the present disclosure.

FIG. 2 is an exemplary diagram illustrating the interior of a housing of the oxygen or hydrogen functional water production device according to the first embodiment of the present disclosure.

FIG. 3 is an exemplary diagram illustrating the oxygen or hydrogen functional water production device according to the first embodiment of the present disclosure.

FIG. 4 is an exemplary diagram illustrating a light emitter provided near a faucet according to the first embodiment of the present disclosure.

FIG. 5 is an exploded perspective view of an electrolytic cell according to the first embodiment of the present disclosure.

FIG. 6 is a cross-sectional view illustrating a static mixer according to the embodiment of the present disclosure.

FIG. 7 is a schematic diagram illustrating an oxygen or hydrogen functional water production device according to a second embodiment of the present disclosure.

FIG. 8 is an exemplary diagram illustrating the interior of a housing of the oxygen or hydrogen functional water production device according to the second embodiment of the present disclosure.

FIG. 9 is a schematic diagram illustrating the oxygen or hydrogen functional water production device according to the second embodiment of the present disclosure.

FIG. 10 is an exploded perspective view of an electrolytic cell according to the second embodiment of the present disclosure.

FIG. 11 is a cross-sectional view illustrating a static mixer according to the second embodiment of the present disclosure.

### DETAILED DESCRIPTION

Embodiments of the present disclosure are illustrated for the purpose of explaining the technical idea of the present disclosure. The scope of the rights according to the present disclosure is not limited to the embodiments presented below or the detailed descriptions of such embodiments.

All technical and scientific terms used in the present disclosure have the meaning generally understood by those of ordinary skill in the art to which the present disclosure pertains, unless otherwise defined. All terms used in the present disclosure are chosen for the purpose of more clearly describing the present disclosure and are not chosen to limit the scope of rights according to the present disclosure.

As used in the present disclosure, expressions such as “comprising”, “including”, “having”, and the like are to be understood as open-ended terms having the possibility of encompassing other embodiments, unless otherwise mentioned in the phrase or sentence containing such expressions.

The singular form described in the present disclosure may include a plural meaning, unless otherwise mentioned. This applies equally to the singular form recited in the claims.

The terms “first”, “second”, and the like used in the present disclosure are used to distinguish a plurality of components from one another, and do not limit the order or importance of the corresponding components.

Hereinafter, embodiments of the present disclosure will be described in detail with reference to the accompanying drawings. The same reference numeral will be used for the same element throughout the drawings, and duplicate descriptions of the same element will be omitted.

The present disclosure relates to an oxygen or hydrogen functional water production device that changes the concentration of dissolved gases (hydrogen or oxygen) in water circulating through the device using dissolved gases (hydrogen or oxygen) generated by the electrolysis of water, thereby providing oxygen water or hydrogen water to enhance solubility, permeability, and physiological effects. Additionally, the present disclosure relates to an oxygen or hydrogen functional water production device that includes a static mixer provided in a flow path through which the functional water circulates to reduce the cluster size of water and dissolved gas (hydrogen or oxygen), thereby providing high-quality functional water with enhanced drinking comfort and improved absorption in the body. Referring to the drawings, the configuration is as follows.

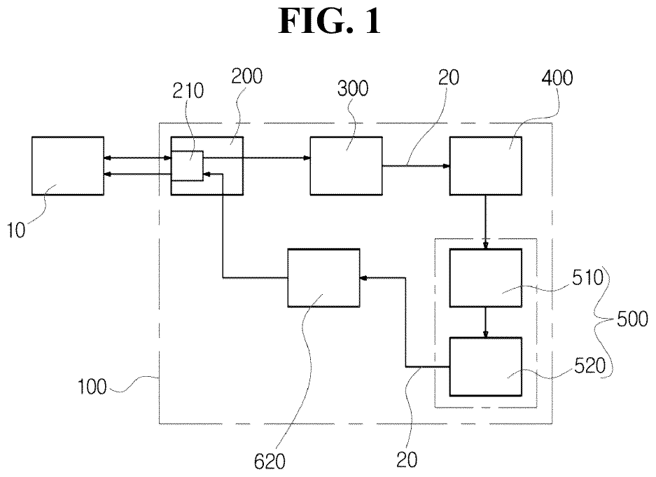

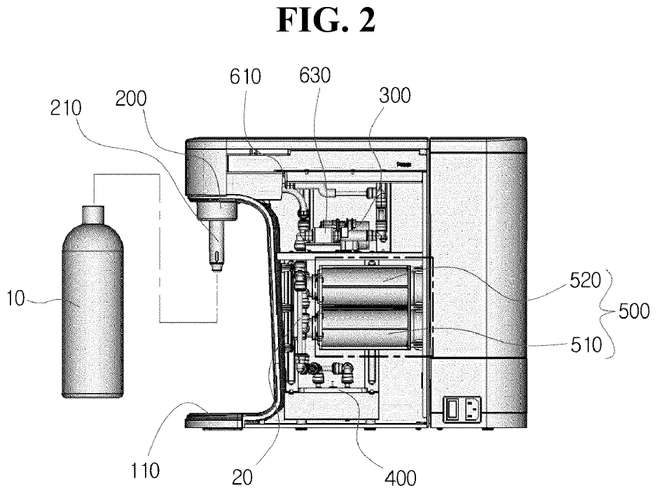

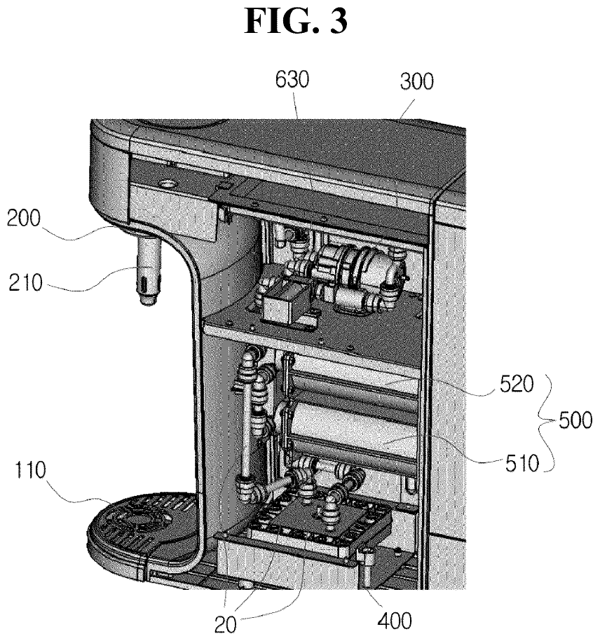

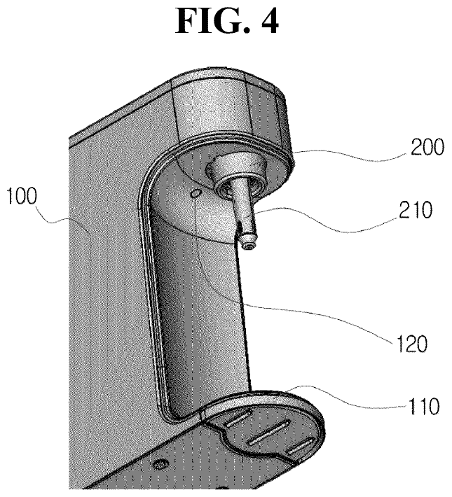

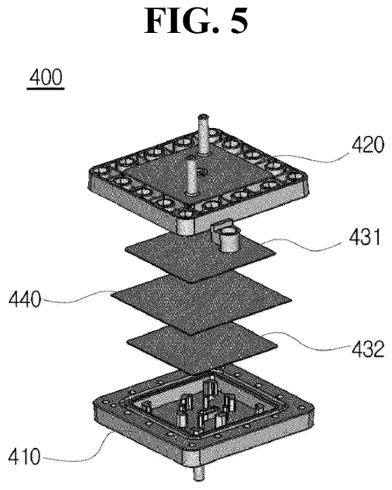

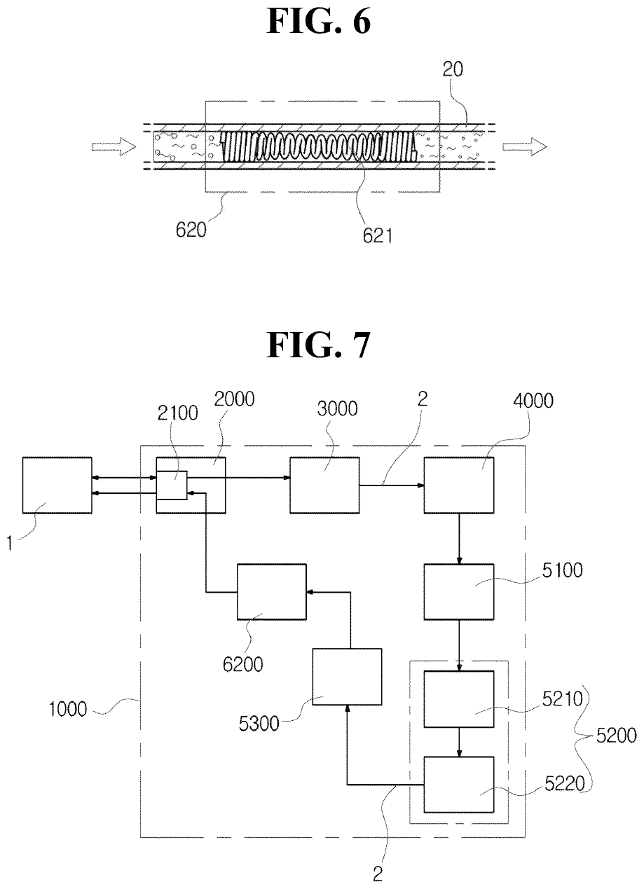

According to a first embodiment of the present disclosure, with reference to FIGS. 1 through 5, the oxygen or hydrogen functional water production device includes a housing 100, a water bottle 10, a faucet 200, a faucet nozzle 210, a circulation pump 300, an electrolytic cell 400, a filter assembly 500, and a static mixer 620.

A water bottle mounting space to accommodate the water bottle 10 is formed at the front of the housing 100, and the faucet 200 to which the water bottle 10 is mounted is provided at an upper side of the water bottle mounting space, and a drip tray 110 is provided at a lower side thereof.

Here, the faucet200 is configured to mount the water bottle 10 filled with a predetermined amount of water. A lower portion of the faucet 200 protrudes from the housing 100 toward the drip tray 110 such that an opening of the water bottle 10 is screw-coupled to the lower portion of the faucet 200.

At the center of the faucet 200, the faucet nozzle 210 is downwardly exposed and extended. When the water bottle 10 is mounted to the faucet 200, the faucet nozzle 210 is inserted into the interior of the water bottle 10 mounted in the faucet 200 through the opening of the water bottle 10. Thus, a water inlet and a water outlet formed at a lower portion of the faucet nozzle 210, the water contained in the water bottle 10 is introduced or the functional water converted into oxygen water or hydrogen water through the electrolytic cell 400 is injected into the water bottle 10.

In this instance, a light emitter 120 is arranged around the faucet 200 located on the front side of the housing 100 and emits light in response to the discharge of the oxygen water or hydrogen water from the faucet nozzle 210.

The light emitter 120 is an LED lamp, and emits light of a corresponding color in response to whether the faucet nozzle 210 is discharging oxygen water or hydrogen water.

For example, when oxygen water is discharged from the faucet nozzle 210, green light is emitted among various colors, but when hydrogen water is discharged from the faucet nozzle 210, blue light is emitted.

Furthermore, inside the housing 100, the circulation pump 300, the electrolytic cell 400, the filter assembly 500, and the static mixer 620 are provided. Water introduced from the water bottle 10 via the faucet nozzle 210 is circulated in the order of the circulation pump 300, the electrolytic cell 400, the filter assembly 500, and the static mixer 620, and then, is discharged back into the water bottle 10 through the faucet nozzle 210.

The circulation pump 300, the electrolytic cell 400, the filter assembly 500, and the static mixer 620 will be described in more detail. First, a water inlet of the circulation pump 300 is connected to the faucet nozzle 210 through a flow path 20 through which water circulates such that inhalation of the water contained in the water bottle 10 is achieved through the water inlet of the faucet nozzle 210 by pumping of the circulation pump 300. The introduced water is pumped by the circulation pump 300, and then, is discharged to the electrolytic cell 400 connected to a water outlet of the circulation pump 300 via the flow path 20.

At this time, a flow sensor 610 is provided in the flow path 20 connecting the faucet nozzle 210 and the water inlet of the circulation pump 300. The flow sensor 610 detects water circulating into the circulation pump 300 and controls the operation of the circulation pump 300 and the electrolytic cell 400.

For example, if the circulation pump 300 and the electrolytic cell 400 operate while water is not circulating, it may cause damage to the circulation pump 300 and the electrolytic cell 400, resulting in shortened lifespan of the circulation pump 300 and the electrolytic cell 400 and malfunctions. Therefore, when the inflow of water into the circulation pump 300 is confirmed through the flow sensor 610, the circulation pump 300 and the electrolytic cell 400 are controlled to be turned ON. Conversely, when the inflow of water into the circulation pump 300 is not detected by the flow sensor 610, they are controlled to be turned OFF.

In addition, the electrolytic cell 400 receives the water discharged by the circulation pump 300 and performs electrolysis within the cell to produce oxygen ions and hydrogen ions, thereby converting the water into oxygen or hydrogen functional water with an increased concentration of dissolved gases (oxygen or hydrogen).

In this instance, the electrolytic cell 400 includes a lower member 410, an upper member 420, a pair of electrode plates 431 and 432, and a proton exchange membrane (PEM) 440.

The lower member 410 is a rectangular hexahedron with an open top surface, and forms a space inside for containing a predetermined amount of water.

Moreover, the upper member 420 is coupled to the lower member 410 and the upper member 420 has the same shape as the lower member 410, with an open bottom surface, and also forms a space inside for containing a predetermined amount of water.

In this instance, when the lower member 410 and the upper member 420 are coupled, high-tension bolts are fastened along the rim of the lower member 410 and the upper member 420 to prevent any leakage or seepage.

Here, on the top surface of the upper member 420, a water inlet through which water flows in and a water outlet through which the functional water converted by the concentration change of the dissolved gas (oxygen or hydrogen) is discharged are formed.

Furthermore, when the lower member 410 and the upper member 420 are coupled, the proton exchange membrane 440 and the pair of electrode plates 431 and 432 are arranged between the lower member 410 and the upper member 420.

In this instance, the electrode plates 431 and 432 are respectively in surface contact with an upper side of the proton exchange membrane 440 and a lower side of the proton exchange membrane 440 relative to the proton exchange membrane 440.

The proton exchange membrane 440 is located between the anode and the cathode, and allows only protons to pass while blocking electrons. It must exhibit excellent ion conductivity, low electrical resistance, chemical stability, mechanical strength, and resistance to physical deformation, thus, is formed of a polymer membrane composed of either a perfluorinated polymer or a hydrocarbon-based polymer.

The pair of electrode plates 431 and 432 are made of titanium sheets coated with platinum, and are respectively in surface contact with the upper side and the lower side of the proton exchange membrane 440 relative to the proton exchange membrane 440.

Here, inside the lower member 410 and the upper member 420, a support is formed at a designated position to support the proton exchange membrane 440 of which the upper side and the lower side are in surface contact with the electrode plates 431 and 432, ensuring that the proton exchange membrane 440 is always located at the designated position.

The electrolytic cell 400 switches the polarity applied to the pair of electrode plates 431 and 432 according to an oxygen water mode or a hydrogen water mode into the anode (+) or the cathode (−).

For example, in the oxygen water mode, the upper electrode plate 431 functions as the anode (+), and the lower electrode plate 432 functions as the cathode (−).

In this instance, oxygen is generated at the anode (+) according to the electric current (I) and Faraday's law, and is dissolved in the water introduced into the electrolytic cell 400.

Here, chemical formulas to generate oxygen at the anode and the cathode are as follows.

Anode reaction formula is as follows:

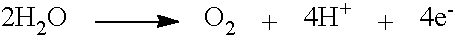

Cathode reaction formula is as follows:

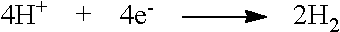

Therefore, the oxygen gas generated by electrolysis in the electrolytic cell 400 comes into contact with water molecules on the surface of the water introduced into the electrolytic cell 400, promotes dissolution through gas diffusion, and the dissolution continues until concentration equilibrium is reached. The hydrogen gas generated by electrolysis in the electrolytic cell 400 is discharged through a vent formed in the lower member 410 of the electrolytic cell 400.

For example, when [symbol] of mineral water is circulated at a voltage of 10 V, a current of 3 A, and a circulation rate of 1.3 [symbol] , the oxygen water mode is operated for 10 minutes and hydrogen water mode is operated for 5 minutes. Then, the concentrations of dissolved gases are shown in Table 1 below.

TABLE 1

| | Oxygen | Ozone | Hydrogen | |
|---|---|---|---|---|
| Number | Concentration | Concentration | Concentration | Water |
| of | (ppm) | (ppm) | (ppb) | temperature |
| Times | 10 min | | 5 minutes | ° C. |
| 1 | 21 | 0.02 | 1,360 | 21.2 |
| 2 | 22.1 | 0.02 | 1,440 | |
| 3 | 24.5 | 0.01 | 1,380 | |
| 4 | 24.5 | 0.02 | 1,440 | |
| 5 | 23.92 | 0.01 | 1,450 | |
| 6 | 22.7 | 0.02 | 1,510 | |
| 7 | 23.5 | 0.02 | 1,480 | |
| 8 | 22.46 | 0.01 | 1,430 | |
| 9 | 25 | 0.01 | 1,510 | |
| 10 | 24.36 | 0.02 | 1,470 | |
| Average | 23.404 | 0.016 | 1,447 | 21.2 |

Additionally, the current density of the electrolytic cell 400 having a vertically symmetrical electrode structure, where the electrode plates 431 and 432 are respectively in surface contact with the upper side of the proton exchange membrane 440 and the lower side of the proton exchange membrane 440 relative to the proton exchange membrane 440, is in the range of 500 to 833 A/m². Through the oxidation of water, reactive oxygen species (ROS) are generated to suppress bacterial proliferation inside the electrolytic cell 400.

The functional water generated in the electrolytic cell 400 is circulated to the filter assembly 500 via the water outlet, and the filter assembly 500 removes ozone from the functional water discharged from the electrolytic cell 400.

The filter assembly 500 includes a first filter 510 and a second filter 520. The first filter 510 is composed of activated carbon blocks or activated carbon fiber (ACF), preferably the activated carbon fiber (ACF).

The ozone adsorption mechanism of the activated carbon fiber (ACF) is based on the extremely large surface area and porous structure thereof, enabling both chemical adsorption and physical adsorption.

Ozone has strong oxidative properties, and is adsorbed onto the surface of the ACF through physical and chemical interactions.

In this instance, the physical adsorption generally occurs via the non-covalent bonding (van der Waals force), and the chemical adsorption is reversible and influenced by temperature and pressure.

The activated carbon fiber (ACF) not only physically adsorbs ozone, but also acts as a catalyst to decompose two ozone molecules on the surface and chemically converts the two ozone molecules into three oxygen molecules, as shown in the following chemical formula.

Chemical formula is as follows:

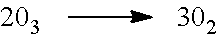

The oxygen water that passes through the first filter 510 circulates to the second filter 520. The second filter 520 is a mineral filter in which potassium bisulfite (KHSO₃) is impregnated into activated carbon. As the functional water passes through the second filter 520, any remaining ozone is secondarily adsorbed and removed, and bisulfite ions (HSO₃—) impregnated into the activated carbon is dissolved in water to raise the pH and convert the water into mildly alkaline water, thereby reducing the volatility of oxygen gas and increasing the stability.

Accordingly, the water that has passed through the filter assembly 500 is discharged to the water bottle 10 by the continuous operation of the circulation pump 300. The above process is repeated, gradually increasing the concentration of dissolved oxygen in the water stored in the water bottle 10.

In addition, the second filter 520 may be an alkaline bead filter to increase the concentration of dissolved gases in the functional water.

Inside the second filter 520, porous alkaline beads composed of alkaline substances capable of releasing potassium (K⁺) and sodium (Na⁺). As water passes through the filter, the porous alkaline beads elute alkaline ions, increasing the pH of the water and enhancing the solubility and stability of dissolved oxygen (O₂) or other gases.

Moreover, when switched to hydrogen water mode, the upper electrode plate 431 provided in the electrolytic cell 400 functions as the cathode (−) and the lower electrode plate 432 functions as the anode (+).

As described above, by reversing the polarity of the electrode plates 431 and 432 provided in the electrolytic cell 400, hydrogen functional water is generated. With a 5-minute operation, the concentration of hydrogen gas reaches a level close to the saturation under atmospheric pressure (approximately 1500 ppb).

The functional water that has passed through the filter assembly 500 is discharged into the water bottle 10 through the faucet nozzle 210.

Here, the water discharged by the circulation pump 300 may first enter the filter assembly 500, be converted into alkaline water in the filter assembly 500, and then be circulated to the electrolytic cell 400.

The electrolysis in the electrolytic cell 400 uses an alkaline electrolyte as the electrolyte. When the electrolytic cell 400 is supplied with water converted into high-pH alkaline water by potassium bisulfite while passing through the filter assembly 500, electrolysis efficiency may be improved, potassium bisulfite adsorbs and decomposes ozone, and slag generation on the electrodes is prevented. Typically, electrode slag is formed when calcium or magnesium is used.

Furthermore, a static mixer 620 is provided in the flow path 20 connecting the electrolytic cell 400 and the filter assembly 500, or in the flow path 20 connecting the filter assembly 500 and the faucet nozzle 210. The static mixer 620 finely decomposes the water flowing through the flow path 20 to generate micro-bubble water.

The static mixer 620 is an hourglass-shaped gas-liquid mixer (static mixer) 621 made of stainless steel and is provided inside the flow path 20. It finely decomposes water molecules, maximizes the contact between water and oxygen or hydrogen gas to micronize the dissolved gas, and reduces the cluster size of the water molecules, thereby providing high-quality functional water with smooth swallowing and excellent absorption in the body.

The gas-liquid mixer is hourglass-shaped such that the diameter of the coil expands toward the front end or the rear end from the center of the coil, while the spacing between the coils becomes denser. One or more, for example, two to eight gas-liquid mixers may be provided inside the flow path 20. Oxygen or hydrogen gas is mixed into the water in the form of small bubbles, and the microbubbles significantly increase the contact surface area with the water, thereby enhancing the gas dissolution rate to generate microbubbles and improving gas saturation and retention.

Additionally, a solenoid valve 630 is provided in the flow path 20 connecting the filter assembly 500 and the faucet nozzle 210. The solenoid valve 630 closes the flow path 20 after the circulation pump 300 stops operating, thereby preventing residual water from dripping from the faucet nozzle 210 due to natural pressure.

Accordingly, in the oxygen or hydrogen functional water production device according to the present disclosure, water stored in the water bottle 10 through the faucet nozzle 210 is absorbed in by the pumping action of the circulation pump 300, and dissolved gases (oxygen or hydrogen) is generated through electrolysis in the electrolytic cell 400 and selected dissolved gases are re-dissolved to convert the water into functional water. Ozone is removed in the filter assembly 500 to convert the water into alkaline water, and then, the cluster size of water and dissolved gas molecules is reduced via the static mixer 620. There is no need to prepare a reservoir to dissolve the oxygen or hydrogen gas generated in the electrolytic cell into the water. As the contact area between the gas and water increases significantly, the gas dissolves faster, microbubbles are generated, and gas saturation and retention are improved, thereby providing high-quality functional water with smooth swallowing and excellent absorption in the body.

In addition, the oxygen or hydrogen functional water production device according to the embodiment of the present disclosure can selectively and easily produce oxygen or hydrogen water through a compact design and an intuitive user interface, and ensure quality and safety of the drinking water. Thus, an integrated system that overcomes limitations of conventional technologies and greatly enhances user convenience can be provided.

The present disclosure provides a technology suitable for applications requiring such characteristics, including health supplementation, food processing, sterilization, agriculture, and industrial uses.

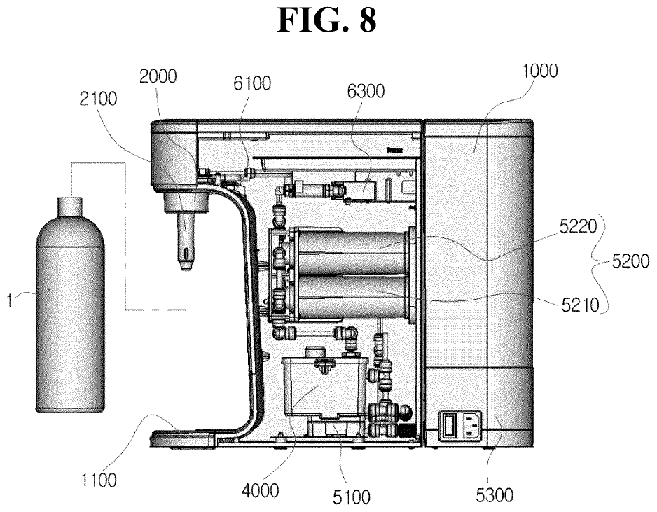

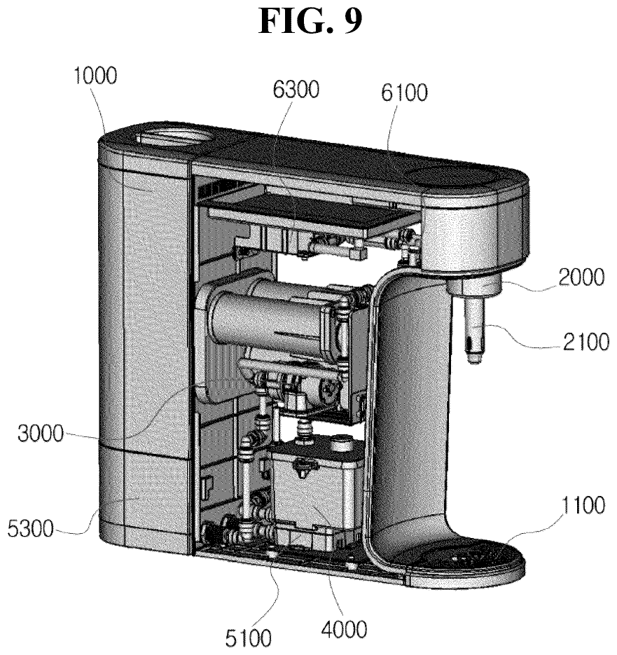

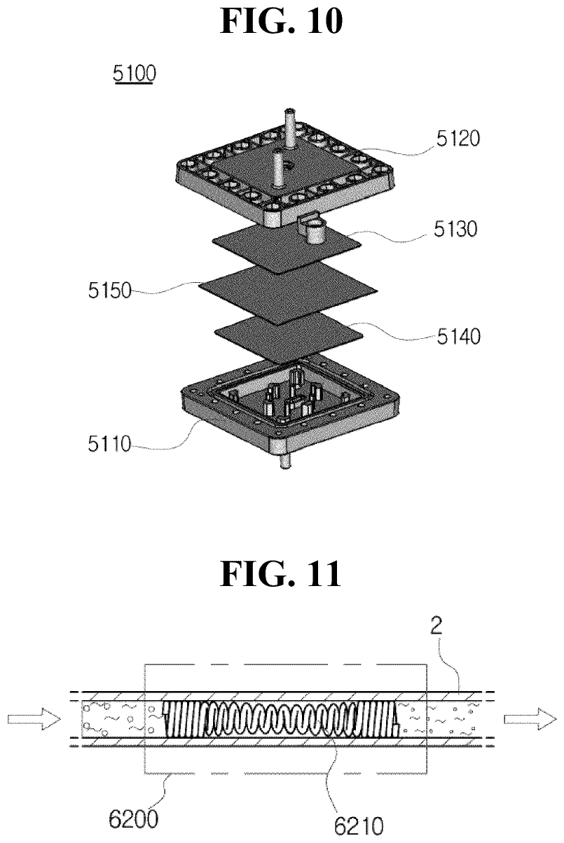

With reference to FIGS. 7 through 11, an oxygen or hydrogen functional water production device according to a second embodiment of the present disclosure includes a housing 1000, a water bottle 1, a faucet 2000, a faucet nozzle 2100, a circulation pump 3000, a purification tank 4000, an electrolytic cell 5100, an ozone filter assembly 5200, a hot water tank 5300, and a static mixer 6200.

At the front of the housing 1000, a water bottle mounting space is formed to accommodate the water bottle 1. The faucet 2000 to which the water bottle 1 is mounted is provided at an upper side of the water bottle mounting space, and a drip tray 1100 is provided at a lower side thereof.

Here, the faucet 2000 is configured to mount the water bottle 1 that stores water. A lower portion of the faucet 2000 protrudes from the housing 1000 toward the drip tray 1100 such that an opening of the water bottle 1 is screw-coupled to the lower portion of the faucet 2000.

In this instance, at the center of the faucet 2000, the faucet nozzle 2100 is downwardly extended and exposed. When the water bottle 1 is mounted to the faucet 2000, the faucet nozzle 2100 is positioned inside the water bottle 1 mounted to the faucet 2000 through the opening of the water bottle 1. Water in the water bottle 1 is introduced via an inlet formed at a lower portion of the faucet nozzle 2100, or the functional water converted into oxygen or hydrogen water through the electrolytic cell 5100 is discharged back into the water bottle 1 via an outlet.

Moreover, the circulation pump 3000, the purification tank 4000, the electrolytic cell 5100, the ozone filter assembly 5200, the hot water tank 5300, and the static mixer 6200 are provided inside the housing 1000. Water introduced from the water bottle 1 via the faucet nozzle 2100 is circulated through the circulation pump 3000 and the purification tank 4000 in order, and then is discharged back to the water bottle 1 through the faucet nozzle 2100 (purification mode).

Furthermore, optionally, after the water is circulated from the purification tank 4000 to the electrolytic cell 5100, dissolved oxygen or hydrogen gas generated by electrolysis in the electrolytic cell 5100 may be dissolved in the water to convert the water into functional water (oxygen water or hydrogen water), and then is discharged into the water bottle 1 through the faucet nozzle 2100 (oxygen/hydrogen mode).

Alternatively, after the water is circulated from the purification tank 4000 or the electrolytic cell 5100 to the hot water tank 5300, the water may be heated in the hot water tank 5300 to a specified temperature to be converted into hot water, and then discharged back into the water bottle 1 through the faucet nozzle 2100 (hot water mode).

In this instance, the mode switching can be performed via a selection button of an interface provided on the surface of the housing 1000.

Here, the circulation pump 3000, the purification tank 4000, the electrolytic cell 5100, the ozone filter assembly 5200, the hot water tank 5300, and the static mixer 6200 will now be described in more detail. First, an inlet of the circulation pump 3000 is connected to the faucet nozzle 2100 and a flow path 2 in which water circulates. By pumping action of the circulation pump 3000, the water contained in the water bottle 1 is introduced through the inlet of the faucet nozzle 2100, and the introduced water is pumped by the circulation pump 3000 and then is discharged to the purification tank 4000 connected to an outlet of the circulation pump 3000 via the flow path 2.

In this instance, a flow sensor 6100 is provided in the flow path 2 connecting the faucet nozzle 2100 and the inlet of the circulation pump 3000. The flow sensor 6100 detects the water circulating to the circulation pump 3000 and controls the operation of the circulation pump 3000 and the electrolytic cell 5100.

For example, if the circulation pump 3000 and the electrolytic cell 5100 operate without water circulation, damage may occur to the circulation pump 3000 and the electrolytic cell 5100, which can shorten the lifespan of the circulation pump 3000 and the electrolytic cell 5100 and cause malfunctions. Therefore, when the inflow of water into the circulation pump 3000 is confirmed through the flow sensor 6100, the circulation pump 3000 and the electrolytic cell 5100 are controlled to be turned ON. Conversely, when the inflow of water into the circulation pump 3000 is not detected by the flow sensor 6100, they are controlled to be turned OFF.

Thereafter, the water discharged from the circulation pump 3000 circulates into the purification tank 4000, and the purification tank 4000 purifies the incoming water by removing foreign substances included in the water discharged from the circulation pump 3000.

In this instance, the filter (not illustrated) that removes foreign substances from the water may be provided inside the purification tank 4000 or at an inflow terminal where water flows into the purification tank 4000.

Additionally, the electrolytic cell 5100 receives the water drained from the purification tank 4000 and electrolysis is performed within the cell to produce oxygen ions and hydrogen ions, thereby converting the water into oxygen or hydrogen functional water with an increased concentration of dissolved gases (oxygen or hydrogen).

In this instance, the electrolytic cell 5100 includes a lower member 5110, an upper member 5120, a pair of electrode plates 5130 and 5140, and a proton exchange membrane (PEM) 5150.

The lower member 5110 is a rectangular hexahedron with an open top surface, and forms a space inside for containing a predetermined amount of water.

Moreover, the upper member 5120 is coupled to the lower member 5110 and the upper member 5120 has the same shape as the lower member 5110, with an open bottom surface, and also forms a space inside for containing a predetermined amount of water.

In this instance, when the lower member 5110 and the upper member 5120 are coupled, high-tension bolts are fastened along the rim of the lower member 5110 and the upper member 5120 to prevent any leakage or seepage.

Here, on the top surface of the upper member 5120, a water inlet through which water flows in and a water outlet through which the functional water converted by the concentration change of the dissolved gas (oxygen or hydrogen) is discharged are formed.

Furthermore, when the lower member 5110 and the upper member 5120 are coupled, the proton exchange membrane 5150 and the pair of electrode plates 5130 and 5140 are arranged between the lower member 5110 and the upper member 5120.

In this instance, the electrode plates 5130 and 5140 are respectively in surface contact with an upper side of the proton exchange membrane 5150 and a lower side of the proton exchange membrane 5150 relative to the proton exchange membrane 5150.

The proton exchange membrane 5150 is located between the anode and the cathode, and allows only protons to pass while blocking electrons. It must exhibit excellent ion conductivity, low electrical resistance, chemical stability, mechanical strength, and resistance to physical deformation, thus, is formed of a polymer membrane composed of either a perfluorinated polymer or a hydrocarbon-based polymer.

The pair of electrode plates 5130 and 5140 are made of titanium sheets coated with platinum, and are respectively in surface contact with the upper side and the lower side of the proton exchange membrane 5150 relative to the proton exchange membrane 5150.

Here, inside the lower member 5110 and the upper member 5120, a support is formed at a designated position to support the proton exchange membrane 5150 of which the upper side and the lower side are in surface contact with the electrode plates 5130 and 5140, ensuring that the proton exchange membrane 5150 is always located at the designated position.

The electrolytic cell 5100 switches the polarity applied to the pair of electrode plates 5130 and 5140 according to an oxygen water mode or a hydrogen water mode into the anode (+) or the cathode (−).

For example, in the oxygen water mode, the upper electrode plate 5130 functions as the anode (+), and the lower electrode plate 5140 functions as the cathode (−).

In this instance, oxygen is generated at the anode (+) according to the electric current (1) and Faraday's law, and is dissolved in the water introduced into the electrolytic cell 5100.

Here, chemical formulas to generate oxygen at the anode and the cathode are as follows.

Anode reaction formula is as follows:

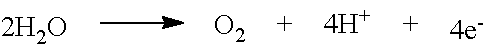

Cathode reaction formula is as follows:

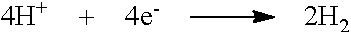

Therefore, the oxygen gas generated by electrolysis in the electrolytic cell 5100 comes into contact with water molecules on the surface of the water introduced into the electrolytic cell 5100, promotes dissolution through gas diffusion, and the dissolution continues until concentration equilibrium is reached. The hydrogen gas generated by electrolysis in the electrolytic cell 5100 is discharged through a vent formed in the lower member 5110 of the electrolytic cell 5100.

In the hydrogen water mode, the upper electrode plate 5130 functions as the cathode (−) and the lower electrode plate 5140 functions as the anode (+).

In this case, oxygen is generated at the anode (+) according to the current (I) and Faraday's law, and dissolves into the water introduced into the electrolytic cell 5100.

Therefore, the hydrogen gas generated by electrolysis in the electrolytic cell 5100 gets in contact with the water molecules on the surface of the water introduced into the electrolytic cell 5100, and due to acceleration of dissolution through gas diffusion, the dissolution is continued until concentration equilibrium is achieved. The oxygen gas generated by electrolysis in the electrolytic cell 5100 is vented through a vent formed in the lower member 5110 of the electrolytic cell 5100.

Moreover, the current density of the electrolytic cell 5100 having a vertically symmetrical structure, where the electrode plates 5130 and 5140 are respectively in surface contact with the upper side of the proton exchange membrane 5150 and the lower side of the proton exchange membrane 5150 relative to the proton exchange membrane 5150, is in the range of 500 to 833 A/m². Through the oxidation of water, reactive oxygen species (ROS) are generated to suppress bacterial proliferation inside the electrolytic cell 5100.

The functional water generated in the electrolytic cell 5100 is circulated to the ozone filter assembly 5200 via the water outlet. The ozone filter assembly 5200 removes ozone from the functional water discharged from the electrolytic cell 5100.

The ozone filter assembly 5200 includes a first filter 5210 and a second filter 5220. The first filter 5210 is composed of activated carbon blocks or activated carbon fiber (ACF), preferably the activated carbon fiber (ACF).

The ozone adsorption mechanism of the activated carbon fiber (ACF) is based on the extremely large surface area and porous structure thereof, enabling both chemical adsorption and physical adsorption.

Ozone has strong oxidative properties, and is adsorbed onto the surface of the ACF through physical and chemical interactions.

In this instance, the physical adsorption generally occurs via the non-covalent bonding (van der Waals force), and the chemical adsorption is reversible and influenced by temperature and pressure.

The activated carbon fiber (ACF) not only physically adsorbs ozone, but also acts as a catalyst to decompose two ozone molecules on the surface and chemically converts the two ozone molecules into three oxygen molecules, as shown in the following chemical formula.

Chemical formula is as follows:

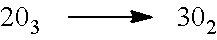

The oxygen water that passes through the first filter 5210 circulates to the second filter 5220. The second filter 5220 is a mineral filter in which potassium bisulfite (KHSO₃) is impregnated into activated carbon. As the functional water passes through the second filter 5220, any remaining ozone is secondarily adsorbed and removed, and bisulfite ions (HSO₃—) impregnated into the activated carbon is dissolved in water to raise the pH and convert the water into mildly alkaline water, thereby reducing the volatility of oxygen gas and increasing the stability.

Accordingly, the water that has passed through the ozone filter assembly 5200 is discharged to the water bottle by the continuous operation of the circulation pump 3000. The above process is repeated, gradually increasing the concentration of dissolved oxygen in the water stored in the water bottle 1.

Furthermore, the second filter 5220 may be an alkaline bead filter to increase the concentration of dissolved gases in the functional water.

Inside the second filter 5220, porous alkaline beads composed of alkaline substances capable of releasing potassium (K⁺) and sodium (Na⁺). As water passes through the filter, the porous alkaline beads elute alkaline ions, increasing the pH of the water and enhancing the solubility and stability of dissolved gases.

Accordingly, after five minutes of operation, the electrolytic cell 5100 reaches near saturation of hydrogen gas under atmospheric pressure (approximately 1500 ppb), and the hydrogen water that has passed through the ozone filter assembly 5200 is discharged into the water bottle 1 through the faucet nozzle 2100.

Here, a static mixer 6200 is provided on the flow path 2 connecting the ozone filter assembly 5200 and the faucet nozzle 2100. The static mixer 6200 finely decomposes the water flowing along the flow path 2 to generate microbubbles.

The static mixer 6200 is an hourglass-shaped gas-liquid mixer (static mixer) 6210 made of stainless steel and is provided inside the flow path 2. It finely decomposes water molecules, maximizes the contact between water and oxygen or hydrogen gas to micronize the dissolved gas, and reduces the cluster size of the water molecules, thereby providing high-quality functional water with smooth swallowing and excellent absorption in the body.

The gas-liquid mixer 6210 is hourglass-shaped such that the diameter of the coil expands toward the front end or the rear end from the center of the coil, while the spacing between the coils becomes denser. One or more, for example, two to eight gas-liquid mixers may be provided inside the flow path 2. Oxygen or hydrogen gas is mixed into the water in the form of small bubbles, and the microbubbles significantly increase the contact surface area with the water, thereby enhancing the gas dissolution rate to generate microbubbles and improving gas saturation and retention.

Additionally, a solenoid valve 6300 is provided in the flow path 2 adjacent to the faucet nozzle 2100. The solenoid valve 6300 closes the flow path 2 after the circulation pump 3000 stops operating, thereby preventing residual water from dripping from the faucet nozzle 2100 due to natural pressure.

The oxygen or hydrogen functional water production device according to the present disclosure has the following advantageous effects.

The oxygen or hydrogen functional water production device can selectively generate oxygen water and hydrogen water using a single apparatus and reduce the cluster size of water and dissolved gases (hydrogen or oxygen) through a static mixer provided in a flow path through which functional water circulates, thereby providing high-quality functional water with enhanced drinking comfort and improved absorption in the body.

Since the static mixer is provided in the flow path through which the water and dissolved gas flow, there is no need for a water tank to dissolve the oxygen or hydrogen gas generated in the electrolytic cell into water. The contact area between the gas and the water is greatly increased, thereby accelerating the dissolution rate of the gas, generating microbubbles, and enhancing the gas saturation and retention.

By limiting the current density of the electrolytic cell to a range of 500 to 833 A/m², the oxygen or hydrogen functional water production device can generate reactive oxygen species (ROS) through the oxidation of water to suppress bacterial proliferation inside the electrolytic cell, thereby providing hygienic functional water at all times.

The technical idea of the present disclosure has been described heretofore with reference to some embodiments and examples illustrated in the accompanying drawings. However, it is to be understood that various substitutions, modifications, and alterations may be made without departing from the technical idea and scope of the present disclosure that can be understood by those of ordinary skill in the technical field to which the present disclosure pertains. In addition, it is to be understood that such substitutions, modifications, and alterations fall within the scope of the appended claims.

What is claimed is:

1. An oxygen or hydrogen functional water production device, comprising:
a water bottle containing water;
a faucet located on a front side of a housing and configured to receive the water bottle;
a faucet nozzle provided in the faucet and configured, when the water bottle is mounted to the faucet, to be positioned inside the water bottle, to draw the water contained in the water bottle, and to discharge water circulated through a flow path inside the housing;
a circulation pump connected to the faucet nozzle via the flow path through which water circulates, and configured to pump the water drawn by the faucet nozzle so as to circulate the water through the flow path;
an electrolytic cell provided on the flow path, configured to electrolyze water introduced therein to generate oxygen and hydrogen gases so as to convert the water into functional water with a changed concentration of dissolved gases, and configured to discharge the functional water;
a filter assembly provided on the flow path, configured to convert the water introduced therein into alkaline water while removing ozone from the water introduced therein, and configured to discharge the alkaline water; and
a static mixer provided on the flow path, and configured to mix the water and gas flowing through the flow path so as to generate microbubbles.

2. The oxygen or hydrogen functional water production device according to claim 1, wherein the electrolytic cell comprises:
a lower member formed as a hexahedron with an open top surface and an internal space;
an upper member coupled to an upper side of the lower member and formed as a hexahedron with an open bottom surface and an internal space;
a proton exchange membrane arranged in a space between the lower member and the upper member, and allowing only hydrogen ions to pass through; and
a pair of electrode plates respectively placed in surface contact with upper and lower sides of the proton exchange membrane to form electrodes.

3. The oxygen or hydrogen functional water production device according to claim 2, wherein each of the pair of electrode plates comprises:
a plate-shaped titanium base; and
a platinum coating formed on the surface of the titanium base.

4. The oxygen or hydrogen functional water production device according to claim 1, wherein the electrolytic cell is configured to generate reactive oxygen species (ROS) through water oxidation at a current density in the range of 500 to 833 A/m².

5. The oxygen or hydrogen functional water production device according to claim 1, wherein the filter assembly comprises:
a first filter configured to remove ozone from the water discharged from the electrolytic cell; and
a second filter configured to elute minerals into the water discharged from the first filter so as to convert the water into alkaline water.

6. The oxygen or hydrogen functional water production device according to claim 5,
wherein the first filter comprises one of a compressed activated carbon block and an activated carbon fiber, and
wherein the second filter comprises porous beads processed by impregnating activated carbon with potassium metabisulfite (KHSO₃).

7. The oxygen or hydrogen functional water production device according to claim 1, wherein the static mixer comprises a gas-liquid mixer having a coil shape, and
wherein, from the center of the coil toward a front end or arear end, a diameter of the coil increases and a spacing between adjacent turns of the coil decreases.

8. The oxygen or hydrogen functional water production device according to claim 1, further comprising:
a flow sensor provided on a section of the flow path connecting the faucet nozzle and the circulation pump, and configured to detect water flowing from the faucet nozzle to the circulation pump and to control the operation of the circulation pump and the electrolytic cell.

9. The oxygen or hydrogen functional water production device according to claim 1, further comprising:
a solenoid valve provided on a section of the flow path connecting the filter assembly and the faucet nozzle, and configured to close the section of the flow path after the operation of the circulation pump is terminated so as to prevent remaining water from dripping from the faucet nozzle due to residual pressure.

10. The oxygen or hydrogen functional water production device according to claim 1, further comprising:
a purification tank provided on the flow path, and configured to remove foreign substances from the water introduced therein and to discharge purified water; and
a hot water tank provided on the flow path, and configured to heat the water introduced therein to a predetermined temperature and to discharge hot water.

11. The oxygen or hydrogen functional water production device according to claim 1, further comprising:
a light emitter disposed adjacent to the faucet, and configured to emit light of a selected color corresponding to the oxygen or hydrogen water discharged from the faucet nozzle.

12. The oxygen or hydrogen functional water production device according to claim 1,
wherein, after the generation of oxygen functional water is completed, the electrolytic cell is turned off and the circulation pump remains turned on to perform idle circulation for one to two minutes, thereby circulating ozone, which is generated during the generation of oxygen in the electrolytic cell, to the filter assembly for removal.
